(19) United States
(12) Patent Application Publication
(10) Pub. No.: US 2008/0155544 A1
(43) Pub. Date: Jun. 26, 2008

(54) DEVICE AND METHOD FOR MANAGING PROCESS TASK FAILURES

(75) Inventors: Olivier Soussiel, Fonsorbes (FR); Christophe Caillaud, Blagnac (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY SUR SEINE (FR)

(21) Appl. No.: 11/962,048

(22) Filed: Dec. 20, 2007

(30) Foreign Application Priority Data
Dec. 20, 2006 (FR) 06 11087

(51) Int. Cl. G06F 9/46

(52) U.S. Cl. 718/100

(57) ABSTRACT

The field of the invention is that of process task failure management. The invention relates to an execution failure management method for tasks APᵢ of a process, the process comprising a number of tasks equal to N, i denoting an index identifying the tasks and being an integer number between 1 and N, an execution of the task APᵢ being started up according to a startup mode MDDᵢ. According to the invention, the startup mode of the tasks APᵢ of the process following a failure affecting a task AP_{ID} depends on a history of the failures that have affected each of the tasks individually.

### RELATED APPLICATIONS

The present application is based on, and claims priority from, French Application Number 06 11087, filed Dec. 20, 2006, the disclosure of which is hereby incorporated by reference herein in its entirety.

### TECHNICAL FIELD

The field of the invention is that of process task failure management.

### BACKGROUND OF THE INVENTION

The invention relates more specifically to complex processes having a critical function, such as, for example, a Flight Management System (FMS) on board an aircraft.

Normally, a process or a complex software application can be broken down into a number of tasks. These tasks are executed independently of each other and each have a set of local data specific to the task and a set of common data shared between the tasks. The tasks act on these various data, and normally have a number of operating modes which correspond to more or less complex algorithms, respectively called nominal mode and degraded modes.

When a process handles a critical function, a failure of one of the tasks that make up the process can lead to a temporary or permanent loss of all of the function of the process. For example, for a flight management system FMS on board an aircraft, a software exception or a convergence divergence affecting a path plotting algorithm can have very serious consequences on the control of the aircraft.

The process is normally designed in such a way as to minimize the consequences of the failures of the tasks of which it is composed. This minimizing can be obtained, on the one hand, by preventing the failures from occurring, and on the other hand, by providing mechanisms whereby, after a detection of a failure, the failing task and the process are quickly returned to a stable state.

Failures affecting tasks of the process can be avoided by taking particularly draconian precautions when designing the tasks of the process to identify situations that can induce failures.

Mechanisms are provided for a failure not to place the process in a recurrent unstable state, and to do this, the mechanism consists, for example, in interrupting the execution of the task that has been detected as failed and restarting the execution of this task either in degraded mode or by modifying the data set that it uses.

Because of the large quantity of information that a process receives during its execution, it is economically not possible to exhaustively envisage all the combinations of data presented to the process in process design, coding and test phases. For example, an FMS on board an aircraft concentrates data obtained from sensors for navigation (IRS, standing for Inertial Reference System”, GPS standing for Global Positioning System, etc.), data obtained from navigation databases to generate the electronic flight plan and its reference lateral path, data from performance databases for generating predictions along the flight plan and, finally, data from manual inputs coming from the crew, normally to initialize the computations, or automatic inputs via a ground/onboard digital data link, known as a “Datalink”, coming from the airline that operates the aircraft or from control centres, in which case the term “Air Traffic Control” (ATC) applies. To this combination of data can be added the combination of the operating modes of the various tasks: namely, in all, a combination that is so extensive that it is impossible to envisage during exhaustive tests.

To quickly remove the process from an unstable state in which it has been placed by a failure of one of its tasks, it is standard practice to use a task failure management device which is incorporated in the system executing the process.

The main function assigned to such a task failure management device is to avoid a total, temporary or permanent, loss of the function of the process or of the data for which the process is responsible. In practice, it is these total losses that lead to the most serious consequences: in the case of the FMS, a temporary loss or an interruption of the execution of the acquisition of the GPS position of the aircraft by the FMS can be tolerated, but the simultaneous interruption of all the tasks that make up the FMS is extremely damaging for an aircraft pilot.

Task failure management devices are known from the prior art, which, when a failure of the task is detected, selectively interrupt one or more tasks of the process and start up a new execution of these tasks. The new execution of the task is started up in an operating mode that is different from the prior operating mode and/or by employing a predefined data set that is different from that previously employed. The determination of the operating mode or of the data set employed follows a certain logic.

The logic employed by the devices of the prior art is more often than not based on a count of a number of failures of the tasks of the process. Following a failure detection, a corrective action is taken. The more failures of the process are detected that appear to be interlinked, the more severe is the effect of the corrective measure on the operation of the process. To describe the corrective actions, usually different types of process task execution startup types which follow an execution interruption are defined:
A first type of startup consists in starting up the execution of the failing task or of all the tasks of the process by employing a nominal operating mode and a data set identical to that employed by the task when the previous execution of the task was interrupted;
A second type of startup consists in starting up the execution of all the tasks of the process by employing one or more reinitialized data sets, the process task operating mode being the nominal mode;
A third type of startup consists in starting up the execution of all the tasks of the process by employing a so-called “degraded” operating mode and one or more reinitialized data sets.

A degraded mode corresponds to a mode of operation that is less efficient than the nominal mode, for example implementing an algorithm of lesser complexity than the algorithm implemented in the nominal operating mode.

The second type of startup is normally considered as placing the failing task in a state that is more stable than that to which a startup of the first type leads, but it presents the drawback of resulting in a loss of data;

The third type of startup is normally considered as placing the failing task in a state that is more stable than that to which a startup of the second type leads, but it presents the drawback of resulting in a loss of data and reducing the functions of the process.

The devices of the prior art have greatly reduced the occurrences of total loss of the function of the processes. However, the process task failure management devices of the prior art suffer from a number of drawbacks.

A first drawback of the methods according to the prior art lies in the global nature of the count of the failures affecting the tasks of the process that they implement. The global nature of the count does not make it possible to distinguish a situation in which all the tasks are affected more or less randomly from a failure of a situation in which a particular task is affected by repeated failures.

A second drawback, linked to the first drawback, arises from the fact that by preventing an identification of a particular task that is more fragile than the others, that is, an identification of a task more frequently affected by a failure than the others, the methods of the prior art also de facto prevent an analysis from being conducted to determine the origin of the failures affecting this particular task. In practice, once a particularly failure-prone task is identified, it is possible to investigate to determine whether the failure is linked to its data set or to an instability in its operating mode.

This investigation consists, for example, in successively interrupting the execution of the failing task then in restarting this execution in a startup mode defining an operating mode which is degraded compared to the previous execution, and/or a data set that is reduced relative to the previous execution.

For example, following a detection of a failure affecting a task AP, a first interruption and a first restart of the execution of the task AP were carried out. If a second failure is detected affecting this task AP, and the second failure appears to be linked with the first, the execution of the task AP is once again interrupted and then restarted, but this time with a different data set.

If, subsequently, the task AP is no longer affected by any failure, it can be concluded that the data set was the origin of the failure, otherwise, it is possible to continue the investigation by subsequently once again modifying the data set or even the operating mode.

Finally, for certain processes, the consequences of a loss of a data set, however momentary, are so serious that efforts are always made to enhance the performance of the task failure management devices. In particular, efforts are made to avoid losing a data set of a non-failing task by delaying the application of an ultimate corrective action which consists in reinitializing the data sets of all the tasks of the process before an ultimate startup of the tasks of the process. In the case of the FMS, it is in practice considered that the data linked to the flight plan are so sensitive that it is desirable to retain them as long as possible.

### SUMMARY OF THE INVENTION

The object of the present invention is to overcome the drawbacks of the task failure management devices of the prior art to increase the availability of a maximum number of tasks of a process when recurrent failures affect the tasks of the process.

More specifically, the subject of the invention is an execution failure management method for tasks APᵢ of a process, the process comprising a number of tasks equal to N, i denoting an index identifying the tasks and being an integer number between 1 and N, an execution of the task APᵢ being started up according to a startup mode MDDᵢ, characterized in that the startup mode of the tasks APᵢ of the process following a failure affecting a task AP_{ID} depends on a history of the failures that have affected each of the tasks individually.

A first advantage of the method according to the invention is that it has the facility to take account of failure information on the scale of an individual task and no longer on the scale of the process. In other words, a corrective action applied by a method according to the invention, following a current failure detection of a task AP_{ID} has an effect on the tasks APᵢ which can depend on whether:
the current failure affects the task AP_{ID};
the task AP_{ID} has, in the past, been affected by a number of failures equal to CPT_{ID};
a previous startup mode of the task APᵢ, the last on-time startup mode, is the mode MDDᵢ.

This facility makes it possible to graduate the effect of the corrective measures: take, for example, a corrective measure taken following a detection of a current failure affecting the task AP_{ID} of a process. This corrective measure defines a startup mode of a task APᵢ of the process which is all the more restrictive compared to the previous startup mode of the task APᵢ when:
the task AP_{ID} is critical to the process,
the number of failures having affected the task AP_{ID} in the past is high, and
the number of startups performed by the task APᵢ is high.

A second advantage of the method according to the invention is that a data set Dᵢ of a task APᵢ which is aborted following the application of a corrective action can be re-employed on an application of a subsequent corrective action. In practice, the data sets of the tasks APᵢ are stored before any interruption of a task by applying a corrective measure. It is advantageous to start up a task execution with a data set that has been proven in a prior execution.

The invention also relates to a failure management device for tasks APᵢ of a process, said device implementing a method according to the invention, said device detecting a current execution failure affecting a task AP_{ID} of the process, the detection of the current failure following a prior detection of a failure, called prior failure, having affected one of the tasks APᵢ, characterized in that it comprises:
a list LIS_INT which contains indices of tasks APᵢ an execution of which can be interrupted and started up individually without disturbing an execution or a startup of another task of the process;
a table TAB which contains theoretical startup modes MD_{i, ID, k} to be used to start up the task APᵢ, following a current failure affecting the task of index ID for the kth time.

The invention finally relates to a system executing a process comprising a number of tasks APᵢ equal to N, i denoting an index identifying the tasks of the process and being an integer number between 1 and N, said system comprising at least N computation units UCᵢ each executing the task APᵢ and a failure management device for tasks APᵢ of a process according to the invention, characterized in that, when a task AP_{ID} is affected by a current failure, a failure detection time NDAT and a failing task index ID are delivered to the failure management device and in that, when the system detects that a current execution failure affects a task AP_{ID}, it produces a failure detection time NDAT and a failing task index ID addressed to said device.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 diagrammatically represents a system comprising three computation units UC₁, UC₂, UC₃, and a task failure management device;

FIG. 2 diagrammatically represents an architecture of a task failure management device according to the prior art;

FIG. 3 represents an exemplary flow diagram of a task failure management method according to the prior art;

FIG. 4 diagrammatically represents a task failure management device according to the invention;

FIG. 5 represents an exemplary flow diagram of a task failure management method according to the invention.

From one figure to the next, the same elements are identified by the same references.

### DETAILED DESCRIPTION OF THE INVENTION

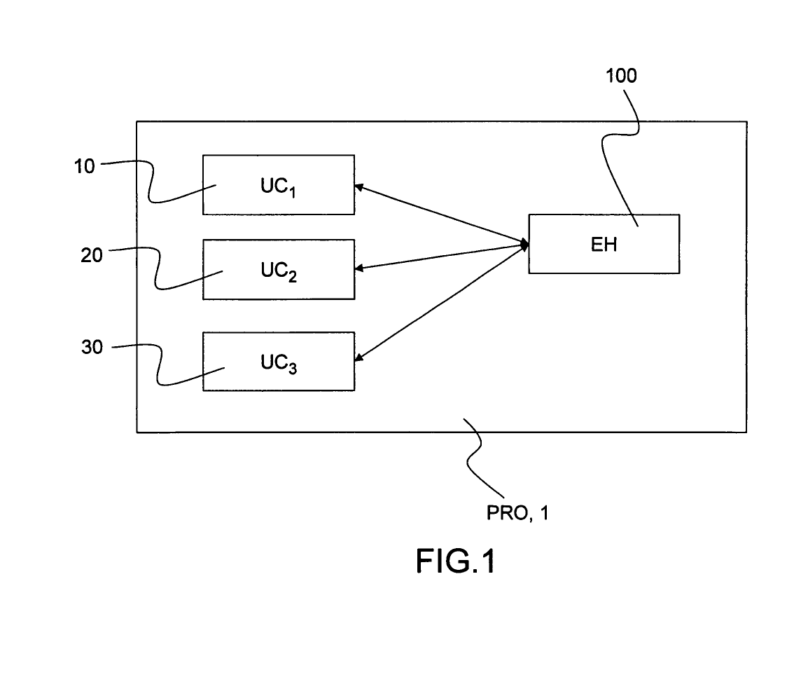

FIG. 1 diagrammatically represents a system PRO, 1, for example an FMS, executing a process. The system PRO, 1 comprises three computation units UC₁, 10, UC₂, 20, UC₃, 30 each executing, for example in parallel, a task AP₁, AP₂, AP₃, and a task failure management device EH, 100 executing a task failure management method according to the prior art. The task failure management device can also be called an “Error Handler”.

Each task AP₁, AP₂, AP₃ is executed according to an operating mode that is specific to it and has a data set that is specific to it. The data set comprises local data that are stored in a volatile memory of the computation unit UC₁, UC₂, UC₃ and common data that are used by a number of tasks of the system PRO 1, the common data being stored in a volatile memory of the system PRO 1.

Within a data set, two types of data can be differentiated:
critical data, which are, for example, for an FMS on board an aircraft, flight plan data communicated by a pilot of the aircraft;
non-critical data, such as, for example, radionavigation setting parameters.

An operating mode describes, for example, an algorithm implemented by a task during its execution. The task has at least one operating mode: a first operating mode, called nominal operating mode, which is the optimum algorithm for the task and performs all the functions handled by the task. Other operating modes of the task, called “degraded modes”, characterize algorithms which comprise one or more limitations compared to the nominal operating mode.

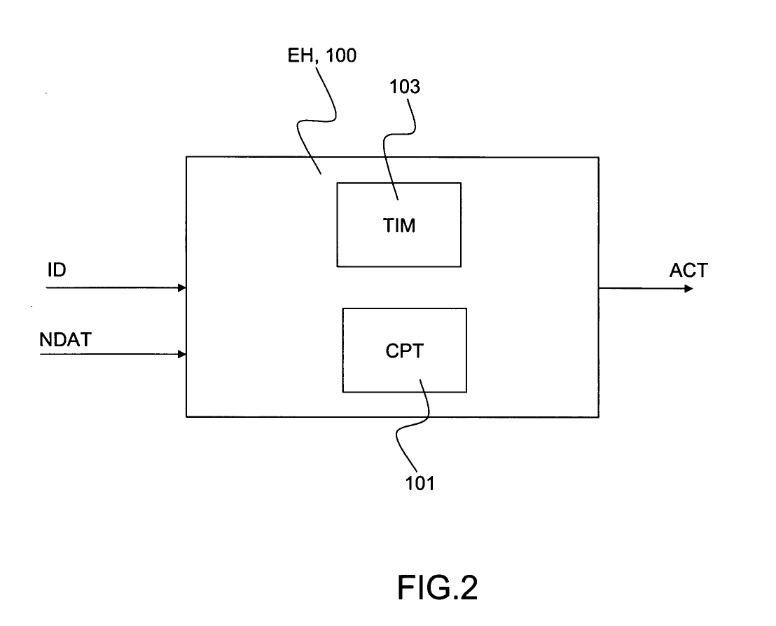

FIG. 2 diagrammatically represents a task failure management device EH, 100 according to the prior art. This representation makes it possible to explain how the task failure management device EH operates.

The error handler EH, 100 is notified when a task AP₁, AP₂, AP₃ is failing. The failure alarm takes the form of a transmission of a failing task index ID and a failure detection time NDAT.

A task AP₁, AP₂, AP₃ can detect, by its own means, that it is failing; the system PRO, 1 can also emit a failure alarm after having detected a failure of one of the tasks. In both cases, the error handler EH receives a failure alarm comprising the failing task index ID and a current failure detection time NDAT.

The error handler EH comprises a listed task failure counter CPT, 101 and a failure time correlation module TIM, 103.

The listed task failure counter CPT comprises a number of execution failures of the tasks APᵢ correlated with the previous failures having affected tasks of the process.

The time correlation module, TIM comprises in particular a time DAT of prior detection of a failure of a task AP₁, AP₂, AP₃.

The counter CPT and the time correlation device TIM are initialized at the moment when the process is started up: once initialized, the counter CPT contains a value equal to 0 and the time DAT comprises a process startup time tᵢₙᵢₜ.

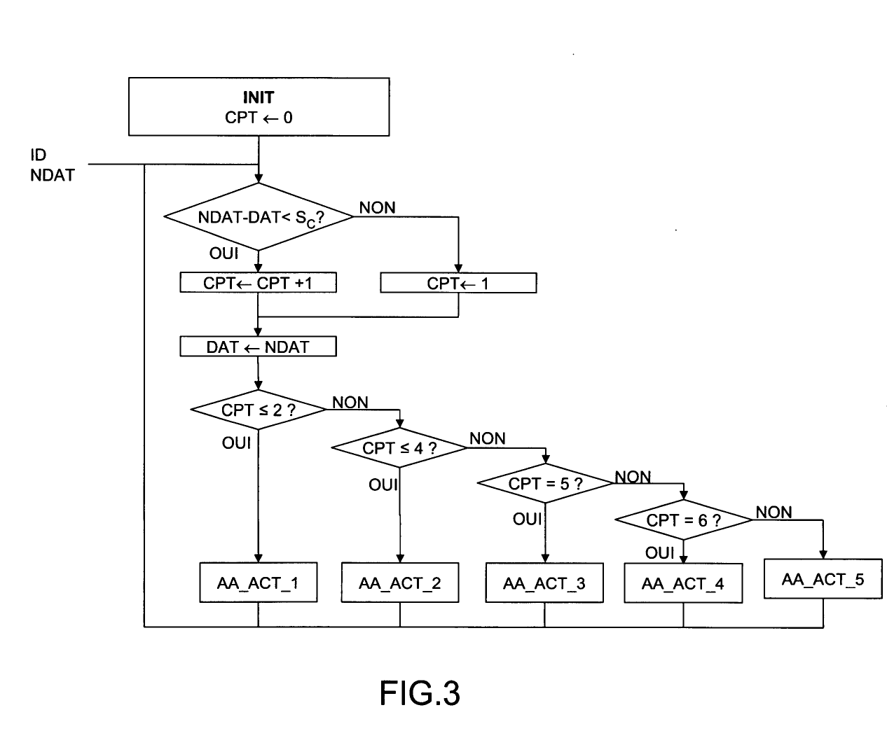

FIG. 3 is an exemplary flow diagram of an error handler method EH, 100 according to the prior art.

Everything begins with an initialization of the counter CPT and an initialization of the time correlation device TIM.

Subsequently, when a current detection of a failure affecting one of the tasks AP₁, AP₂, AP₃, occurs at a time NDAT and the current detection follows on from a prior detection that took place at the time DAT, the value contained in the counter CPT is incremented, if, and only if, the existence of a time correlation between the current failure and the prior failure is determined, that is, if, and only if, a duration separating the current detection time NDAT and the prior detection time DAT is less than a predefined correlation threshold S_{C}. When an absence of correlation between the current failure and the prior failure is determined, a value equal to 1 is substituted for the content of the counter CPT.

In this way, the method according to the prior art differentiates two types of failures affecting tasks of the process: a failure correlated time-wise with a prior failure having affected tasks of the process and an inadvertent failure.

A correlated failure affects a task of the process in conjunction with a prior failure also having affected a task of the process. A current failure is correlated in as much as the current detection is separated from a detection time of a prior failure affecting a task of the process with a duration less than S_{c}.

An inadvertent failure affects a task of the process inadvertently, that is, unrelated to a prior failure affecting a task of the process.

For example, the correlation threshold Sc is equal to 1 minute. When a current failure APᵢ is detected more than a minute after the prior detection, the current failure is considered not to be correlated with the prior failure.

Corrective actions AA_ACT_{—}1, AA_ACT_{—}2, AA_ACT_{—}3, AA_ACT_{—}4, AA_ACT_{—}5, AA_ACT_{—}6, have a gradual effect on the operating mode of the tasks.

For example, when a failure detection affecting the task AP_{ID} is detected, and the value of the counter CPT is 1 or 2, the corrective action AA_ACT_{—}1 applied by the method according to the prior art consists in:
interrupting the execution of the task AP_{ID}, then,
starting up the execution of the task AP_{ID}, according to the nominal operating mode, retaining the data set current at the moment of the interruption.

When a failure detection affecting the task AP_{ID} is detected, and the value of the counter CPT is 3 or 4, the corrective action AA_ACT_{—}2 applied by the method according to the prior art consists in:
interrupting the execution of all the tasks APᵢ of the process, then,
starting up the execution of all the tasks APᵢ according to the nominal operating mode, retaining the data set current at the moment of the interruption.

When a failure detection affecting the task AP_{ID} is detected, and the value of the counter CPT is 5, the corrective action AA_ACT_{—}3 applied by the method according to the prior art consists in:
interrupting the execution of all the tasks APᵢ of the process, then,
starting up the execution of all the tasks APᵢ according to the nominal operating mode, retaining a part of the data set current at the moment of the interruption.

When a failure detection affecting the task AP_{ID} is detected, and the value of the counter CPT is 6, the corrective action AA_ACT_{—}4 applied by the method according to the prior art consists in:
interrupting the execution of all the tasks APᵢ of the method, then,
starting up the execution of all the tasks APᵢ according to the nominal operating mode, initializing all the data sets current at the moment of the interruption.

Finally, when a failure detection affecting the task AP_{ID} is detected, and the value of the counter CPT is strictly greater than 6, the corrective action AA_ACT_{—}5 applied by the method according to the prior art consists in interrupting the execution of all the tasks APᵢ of the process.

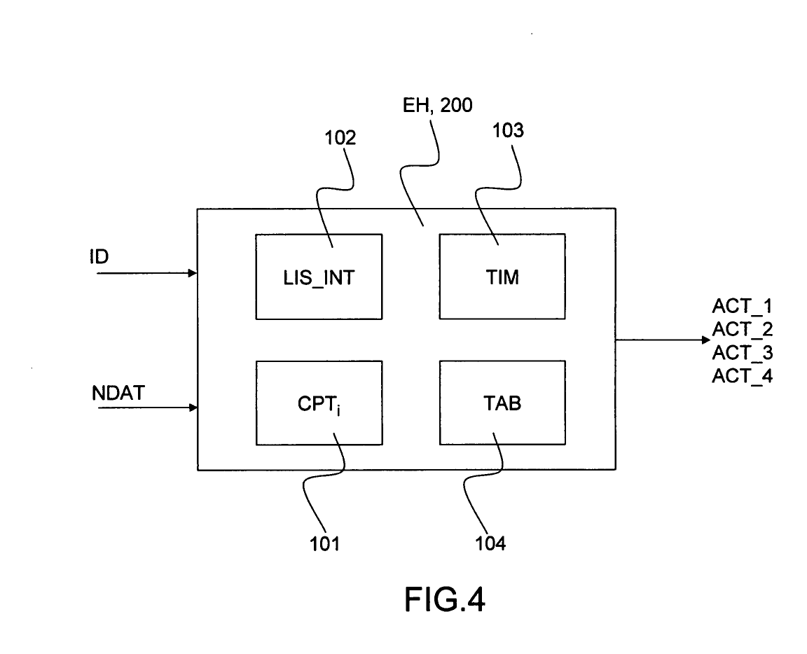

FIG. 4 diagrammatically represents an error handler EH, 200 according to the invention. This representation makes it possible to explain how the error handler EH, 200 according to the invention operates.

The error handler EH, 200 detects a current execution failure affecting a task AP_{ID} of the process. The detection of the current failure follows a prior detection of a failure, called prior failure, which has affected one of the tasks APᵢ of the process.

Advantageously, the device EH comprises:
a list LIS_INT which contains indices of tasks APᵢ for which an execution can be interrupted individually without disturbing an execution of another task of the process;
a table TAB which contains theoretical startup modes MD_{i, ID, k} to be employed to start up the task APᵢ, following a current failure affecting the task of index ID for the kth time.

Advantageously, the device EH, 200 also comprises a listed failure base, which is updated each time a current failure affecting a task APᵢ is detected, said listed failure base comprising:
individual counters CPTᵢ of failures of tasks APᵢ, said individual counters CPTᵢ containing a number of execution failures of the tasks APᵢ correlated with the previous failures;
the prior detection time DAT;
a startup mode MDDᵢ of a previous startup of the task APi, the previous startup being the last on-time startup of the task APi.

Advantageously, the device applies corrective actions ACT_{—}1, ACT_{—}2, ACT_{—}3, ACT_{—}4 having a gradual effect which is a function of a content of the updated listed failure base which aims to interrupt then start up an execution of tasks APᵢ of the process according to a startup mode NMDᵢ.

The invention also relates to a system PRO, 1 executing a process comprising a number of tasks APᵢ equal to N.

The system PRO comprises at least N computation units UCᵢ each executing a task APᵢ and an error handler EH, 200 according to the invention.

i denotes an index identifying the tasks of the process and is an integer number between 1 and N.

According to the invention, the computation units UCᵢ can order a total or partial backup of a set of data of a computation unit UCᵢ, intrinsically distinct, in certain situations, for a subsequent re-use purpose.

For example, when a computation unit UC₁ receives a part of a data set of a computation unit UC₂ and the unit UC₁ has been able to check the integrity of these data, the computation unit UC₁ can order a backup of the part of the data set that has been transmitted to it by the computation unit UC₂. The part of the data set which is backed up normally relates to critical data of the computation unit UC₂, but it is possible for the backup also to contain non-critical data.

This backup is particularly useful because it makes it possible to retain data sets, in whole or in part, whose validity has been proven by a computation unit. These data sets are presumed to be stable and can be used during subsequent startups of the task.

Advantageously, when a first computation unit UCᵢ of a system PRO according to the invention transmits a part of the content of the data set Dᵢ of the task APᵢ that it executes, to a second computation unit UCⱼ of the system PRO according to the invention, where j is an index different from i, the second unit UCⱼ is able to order a backup of the part of the content of the data set Dᵢ that has been transmitted to it.

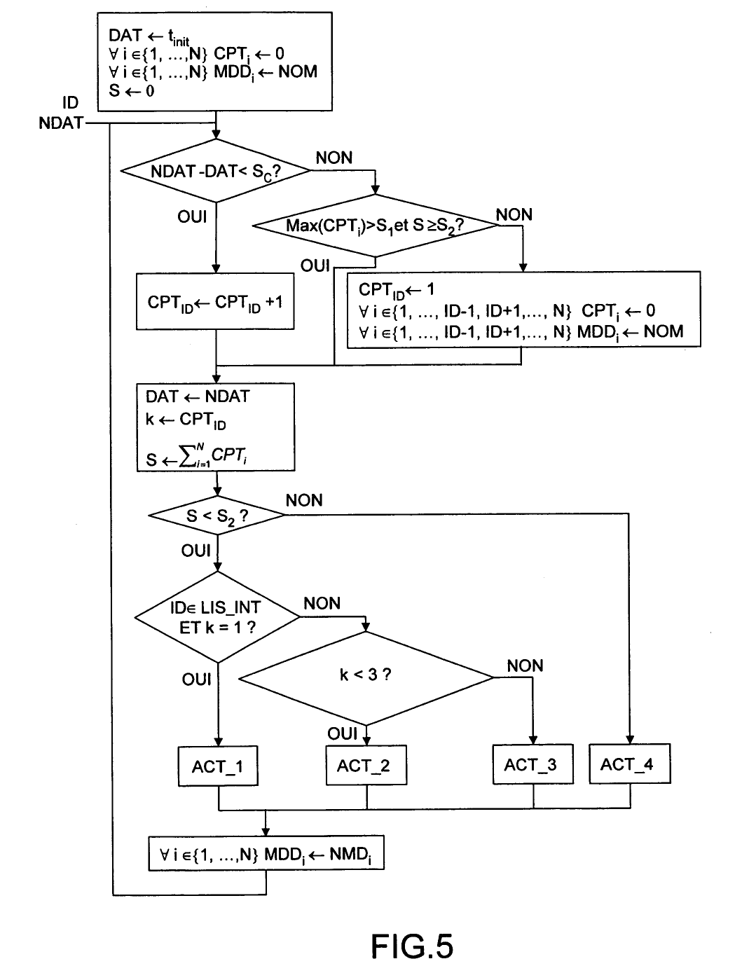

FIG. 5 represents an exemplary flow diagram of an error handler method according to the invention.

Let us consider a process comprising a number of tasks equal to N, i denoting an index identifying the tasks and being an integer number between 1 and N.

Advantageously, the startup mode MDDᵢ uniquely defining an operating mode of the task APᵢ and a content of a data set Dᵢ to be used on starting up the execution of the task APᵢ, a detection of a current execution failure affecting a task AP_{ID} producing a failure detection time NDAT and a failing task index ID, the detection of the current failure following a prior detection of a failure, called prior failure, having affected one of the tasks APᵢ, said prior detection occurring at a time DAT, characterized in that it comprises the following steps:
initializing a listed failure base which comprises:
   individual counters CPTᵢ of failures of tasks APᵢ, said individual counters CPTᵢ containing a number of execution failures of the tasks APᵢ correlated with the preceding failures;
   the time DAT of the prior detection;
   a startup mode MDDᵢ of a preceding startup of the task APᵢ, the preceding startup is the last on-time startup of the task APᵢ;
   an aggregate S equal to a sum of the values of the individual task failure counters CPTᵢ, for all the indices i.
Reading a content of the list LIS_INT;
When the execution failure of the task AP_{ID} is detected, updating the listed failure base;
Applying a corrective action (ACT_{—}1, ACT_{—}2, ACT_{—}3, ACT_{—}4) which has an effect on the execution of the tasks APᵢ, the corrective action applied (ACT_{—}1, ACT_{—}2, ACT_{—}3, ACT_{—}4) is dependent on a content of the updated listed failure base;
When the effect of the applied corrective action (ACT_{—}1, ACT_{—}2, ACT_{—}3, ACT_{—}4) has led to the interruption and then startup of a task APᵢ according to an assigned startup mode NMDᵢ, substituting the assigned startup mode NMDᵢ for the startup mode MDDᵢ, for all the indices i.

The list LIS_INT contains indices of tasks APᵢ for which an execution can be interrupted individually without disturbing an execution of another task of the process.

The execution of the task APᵢ is started up according to a startup mode MDDᵢ, the startup mode MDDᵢ uniquely defining an operating mode of the task APᵢ and a content of a data set Dᵢ to be employed on starting up the execution of the task APᵢ.

A detection of a current execution failure affecting a task AP_{ID} characterized by a failure detection time NDAT and a failing task index ID.

The detection of the current failure follows a prior detection of a failure, called prior failure, which has affected one of the tasks APᵢ, said prior detection taking place at a time DAT.

A first step of the method according to the invention consists in initializing the listed failure base.

Advantageously, the initialization of the listed failure base comprises the following steps:
Initializing the individual counters CPTᵢ; once initialized, the individual counters CPTᵢ contain a value equal to 0, for all the indices i;
Initializing the prior detection time DAT; once initialized, the time DAT comprises a time of startup of the process tᵢₙᵢₜ;
Initializing the startup modes MDDᵢ, for all the indices i; once initialized, the startup modes MDDᵢ comprise a nominal startup mode NOM which corresponds to an optimum operating mode of the task APᵢ;
Initializing the aggregate S; once initialized, the aggregate S contains a value equal to 0.

A second step of the method according to the invention consists in reading a content of the list LIS_INT, for the device to take account of the tasks for which the execution is likely to be interrupted and started up individually, without disturbing an execution of another task of the process.

A third step of the method according to the invention consists in updating the listed failure base.

Advantageously, this update of a listed failure base comprises the following steps:
Determining a maximum value M of the individual counters CPTᵢ for all the indices i;
Determining an existence of correlation between the current failure and the prior failure;
When the existence of a correlation between the current failure and the prior failure is determined, incrementing the value contained in the individual counter CPT_{ID};
When an absence of correlation between the current failure and the prior failure is determined, when the maximum value M is less than or equal to a first threshold S₁, and when the aggregate S is strictly greater than a second threshold S₂, replacing a content of the individual counter CPT_{ID} with a value equal to 1, and initializing the individual counters CPTᵢ, for all the different indices i of ID;
Replacing the prior detection time DAT with the current detection time NDAT;
Determining a theoretical startup mode MD_{i, ID, k} for the task APᵢ, for all the indices i, according to the index ID of the task affected by the current failure and of a value k, where k is equal to a value contained in the individual counter CPT_{ID};
Determining an aggregate S equal to a sum of the values of the individual task failure counters CPTᵢ, for all the indices i;
Determining the corrective action to be applied (ACT_{—}1, ACT_{—}2, ACT_{—}3, ACT_{—}4) according to a comparison of the aggregate S with the second threshold S₂, k and whether the index ID belongs to the list LIS_INT;
Determining the startup mode NMDᵢ assigned to the task APᵢ by the corrective action to be applied (ACT_{—}1, ACT_{—}2, ACT_{—}3, ACT_{—}4), for all the indices i.

Advantageously, the determination of an existence of correlation between the current failure and the prior failure is based on a comparison between a duration separating the current detection time NDAT and the prior detection time DAT and a correlation threshold S_{C}.

Advantageously, the determination of a theoretical startup mode MD_{i, ID, k} for the task APᵢ, following a failure affecting the task of index ID for the kth time, consists in reading information contained in the predefined table TAB.

A fourth step of the method according to the invention consists in applying a corrective action (ACT_{—}1, ACT_{—}2, ACT_{—}3, ACT_{—}4) which has an effect on the execution of the tasks APᵢ. The effect of the applied corrective action depends on a content of the updated listed failure base.

Advantageously, an applied corrective action (ACT_{—}1, ACT_{—}2, ACT_{—}3, ACT_{—}4) comprises a first step for backing up the data sets Dᵢ of the tasks APᵢ, for all the indices i.

Advantageously, when the aggregate S is greater than or equal to the second threshold S₂, a corrective action ACT_{—}4 is applied which also comprises the following steps, for all the indices i:
Interrupting the execution of the task APᵢ;
Starting up the execution of the task APᵢ, according to a startup mode NMDᵢ determined according to the value of the aggregate S.

Advantageously, when the value of the aggregate S is greater than or equal to S₂+2, the startup mode NMDᵢ corresponds to a permanent interruption of the execution of the tasks APᵢ.

The list LIS_INT contains indices of tasks APᵢ for which an execution can be interrupted and started up individually without disturbing the execution of another task of the process.

Advantageously, when the aggregate S is strictly less than S₂, k is equal to 1 and the index ID is part of the list LIS_INT a corrective action ACT_{—}1 is applied which also comprises the following steps:
Interrupting the execution of the task AP_{ID};
Starting up the execution of the task AP_{ID} according to a startup mode NMD_{ID} identical to the startup mode MDD_{ID} of the preceding startup of the task AP_{ID}.

Advantageously, when the aggregate S is strictly less than the second threshold S₂ and when k is different from 1 or the index ID is not part of the list LIS_INT, and when k is strictly less than 3, a corrective action ACT_{—}2 is applied which also comprises the following steps, for all the indices i:
Interrupting the execution of the task APᵢ;
Starting up the execution of the task APᵢ according to a startup mode NMDᵢ which is identical to the startup mode MDDᵢ of the preceding startup of the task APᵢ.

Advantageously, when the aggregate S is strictly less than the second threshold S₂ and when k is different from 1 or the index ID is not part of the list LIS_INT, and when k is greater than or equal to 3, a corrective action ACT_{—}3 is applied which also comprises the following steps, for all the indices i:
Interrupting the execution of the task APᵢ;
Starting up the execution of the task APᵢ, according to a startup mode NMDᵢ determined from a comparison between the startup mode MDDᵢ of the preceding startup of the task APᵢ and the theoretical startup mode MD_{i, ID, k}.

Advantageously, a startup mode NMDᵢ of a task APᵢ is an integer number, and the higher a value of the startup mode NMDᵢ is, the greater a function difference is between an execution of the task APᵢ started up according to the startup mode NMDᵢ and an execution of the task APᵢ started up according to the nominal startup mode.

Advantageously, the nominal startup mode NOM is 0, and the determination of the startup mode NMDᵢ consists in assigning the startup mode NMDᵢ a value equal to the maximum between the value of the startup mode MDDᵢ and the value of the theoretical startup mode MD_{i, ID, k}.

Advantageously, a theoretical startup mode MD_{i, ID, k} defines a content of a data set Dᵢ to be used on starting up the execution of the task APᵢ which corresponds to a backed-up data set.

A fifth step of the method according to the invention consists in replacing the startup mode MDDᵢ with the assigned startup mode NMDᵢ, for all the indices i, when the effect of the applied corrective action has led to a task APᵢ being interrupted then started up according to an assigned startup mode NMDᵢ.

Moreover, a system PRO, 1 which executes a process comprising a number of tasks APᵢ equal to N and which comprises at least N computation units UCᵢ each executing the task APᵢ and a failure management device for tasks APᵢ of the process according to the invention, operates in a way that can interfere with the flow diagram shown in FIG. 5.

Events external to a system PRO, 1 executing a process, are likely to produce a substantial modification of the data set of certain tasks that make up the process.

For certain well identified events, this substantial modification of data sets is such that it fundamentally modifies the state of the tasks and even affects the state of the process overall. There are situations where the substantial modifications have a positive effect on the stability of the tasks concerned, that is, these modifications place the task concerned in a state that is more stable than that in which it was.

To take account of the effects of these substantial modifications of particular data sets, the system PRO associates with a detection of certain events external to the system an update of the listed failure base of its task failure management device.

Advantageously, the system PRO according to the invention comprises means for detecting events external to the system EV, and an update of the listed failure base of the task failure management device is triggered by a detection of a system external event EV.

For processes such as a flight management system FMS installed on an aircraft, a movement of the aircraft is one example of an external event.

Let us consider, in practice, a task AP₀ of the FMS producing a plot of the flight plan from WAY_POINT entered by a pilot of the aircraft. One data set of the task AP₀ comprising WAY POINTs useful for plotting the flight plan is modified by the displacement of the aircraft when the aircraft has passed one of the WAY_POINTs. If the task AP₀ was affected by a series of successive failures, it is possible that the modification of the data set induced by the displacement of the aircraft is sufficient to place the task AP₀ outside of a context producing the series of failures. The update of the listed failure database of the failure management device is performed to reflect this change of state.

The update is predefined by a designer of the system PRO. Depending on the external event EV detected, the update assigns values contained in the individual counters CPTᵢ of certain predefined tasks.

Advantageously, the update of the listed failure base comprises a step for initializing the individual counters CPTᵢ for tasks whose indices are stored in a list L₁ which depends on the system external event EV detected by the system.

Depending on the external event EV detected, the update affects the values of the startup modes MDDᵢ of a previous startup of certain predefined tasks.

Advantageously, the update of the listed failure base comprises a step for initialization of the startup modes MDDᵢ of a preceding startup for tasks whose indices are stored in a list L₂ which depends on the system external event EV detected by the system.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalent thereof.

1. An execution failure management method for tasks of N process, the process comprising a number of tasks, i denoting an index identifying the tasks and being an integer between 1 and N, an execution of the task being started up according to a startup mode, wherein the startup mode of the tasks of the process following a failure affecting a task depends on a history of the failures that have affected each of the tasks individually, said method comprises the following step:
initializing a listed failure base which comprises:
individual counters CPTᵢ of failures of tasks APᵢ, said individual counters CPTᵢ including a number of execution failures of the tasks APᵢ correlated with the preceding failures;
the time DAT of the prior detection;
a startup mode MDDᵢ of a preceding startup of the task APᵢ, the preceding startup is the last on-time startup of the task APᵢ;
an aggregate S equal to a sum of the values of the individual task failure counters CPTᵢ, for all the indices i.

2. The method according to claim 1, comprising:
the startup mode uniquely defining an operating mode of the task and a content of a data set to be used on starting up the execution of the task, a detection of a current execution failure affecting a task producing a failure detection time and a failing task index, the detection of the current failure following a prior detection of a failure, having affected one of the tasks, said prior detection occurring at a time,:
reading a content of a list;
when the execution failure of the task is detected, updating the listed failure base;
applying a corrective action which has an effect on the execution of the tasks APᵢ, the corrective action applied is dependent on a content of the updated listed failure base;
when the effect of the applied corrective action has led to the interruption and then startup of a task according to an assigned startup mode, substituting the assigned startup mode for the startup mode MDDᵢ, for all the indices i.

3. The method according to claim 2, wherein the initialization of the listed failure base comprises the following steps:
initializing the individual counters; once initialized, the individual counters CPTᵢ contain a value equal to 0, for all the indices i;
initializing the prior detection time; once initialized, the time DAT comprises a time of startup of the process tᵢₙᵢₜ;
initializing the startup modes, for all the indices i; once initialized, the startup modes MDDᵢ comprise a nominal startup mode which corresponds to an optimal operating mode of the task;
initializing an aggregate S; once initialized, the aggregate S contains a value equal to 0.

4. The method according to claim 2, wherein the update of a listed failure base comprises the following steps:
determining a maximum value M of the individual counters for all the indices i;
determining an existence of correlation between the current failure and the prior failure;
when the existence of a correlation between the current failure and the prior failure is determined, incrementing the value contained in the individual counter;
when an absence of correlation between the current failure and the prior failure is determined, when the maximum value M is less than or equal to a first threshold, and when the aggregate S is strictly greater than a second threshold, replacing a content of the individual counter with a value equal to 1, and initializing the individual counters, for all the different indices i of ID;
replacing the prior detection time with the current detection time;
determining a theoretical startup mode for the task, for all the indices i, according to the index ID of the task affected by the current failure and to a value k, where k is equal to a value contained in the individual counter;
determining an aggregate S equal to a sum of the values of the individual task failure counters, for all the indices i;
determining the corrective action to be applied according to a comparison of the aggregate S with the second threshold S₂, k and whether the index ID belongs to the list LIS_INT;
determining the startup mode NMDᵢ assigned to the task by the corrective action to be applied, for all the indices i.

5. The method according to claim 4, wherein the determination of an existence of correlation between the current failure and the prior failure is based on a comparison between a duration separating the current detection time and the prior detection time and a correlation threshold.

6. The method according to claim 4, wherein the determination of a theoretical startup mode for the task, following a failure affecting the task of index ID for the kth time, consists in reading information contained in a predefined table.

7. The method according to claim 4, wherein an applied corrective action comprises a first step for backing up the data sets Dᵢ of the tasks APᵢ, for all the indices i.

8. The method according to claim 7, the list containing indices of tasks for which an execution can be interrupted and started up individually without disturbing the execution of another task of the process, wherein, when the aggregate S is strictly less than the second threshold is equal to 1 and the index ID is part of the list, a corrective action is applied which also comprises the following steps:
interrupting the execution of the task AP_{ID};
starting up the execution of the task according to a startup mode identical to the startup mode MDD of the preceding startup of the task.

9. The method according to claim 7, wherein, when the aggregate S is strictly less than the second threshold and when k is different from 1 or the index ID is not part of the list, and when k is strictly less than 3, a corrective action is applied which also comprises the following steps, for all the indices i:
interrupting the execution of the task;
starting up the execution of the task according to a startup mode which is identical to the startup mode of the preceding startup of the task.

10. The method according to claim 7, wherein, when the aggregate S is strictly less than the second threshold and when k is different from 1 or the index ID is not part of the list, and when k is greater than or equal to 3, a corrective action is applied which also comprises the following steps, for all the indices i:
interrupting the execution of the task;
starting up the execution of the task, according to a startup mode determined from a comparison between the startup mode of the preceding startup of the task and the theoretical startup mode.

11. The method according to claim 10, wherein a startup mode of a task is an integer and in that the higher a value of the startup mode is, the greater a function difference is between an execution of the task started up according to the startup mode and an execution of the task started up according to the nominal startup mode.

12. The method according to claim 11, wherein the nominal startup mode NOM is 0, and in that the determination of the startup mode consists in assigning the startup mode a value equal to the maximum between the value of the startup mode and the value of the theoretical startup mode.

13. The method according to claim 7, wherein, when the aggregate S is greater than or equal to the second threshold S₂, a corrective action is applied which also comprises the following steps, for all the indices i:
interrupting the execution of the task;
starting up the execution of the task, according to a startup mode determined according to the value of the aggregate S.

14. The method according to claim 13, wherein, when the value of the aggregate S is greater than or equal to S₂+2, the startup mode corresponds to a permanent interruption of the execution of the tasks APᵢ.

15. The method according to one of claims 7, wherein a theoretical startup mode MD_{i, ID, k} defines a content of a data set Dᵢ to be used on starting up the execution of the task APᵢ which corresponds to a backed-up data set.

16. A failure management device for tasks APᵢ of a process, said device implementing a method according to claim 1, said device detecting a current execution failure affecting a task AP_{ID} of the process, the detection of the current failure following a prior detection of a failure, called prior failure, having affected one of the tasks APᵢ, comprising:
a list LIS_INT which contains indices of tasks APᵢ an execution of which can be interrupted individually without disturbing an execution of another task of the process;
a table TAB which contains theoretical startup modes MD_{i, ID, k} to be used to start up the task APᵢ, following a current failure affecting the task of index ID for the kth time.

17. The device according to claim 16, further comprising a listed failure base, which is updated on each detection of a current failure affecting a task APᵢ, said listed failure base comprising:
individual counters CPTᵢ of failures of tasks APᵢ, said individual counters CPTᵢ containing a number of execution failures of the tasks APᵢ correlated with the preceding failures;
the time DAT of the prior detection;
a startup mode MDDᵢ of a preceding startup of the task APi, the preceding startup being the last on-time startup of the task APi;
and in that the device applies corrective actions (ACT_{—}1, ACT_{—}2, ACT_{—}3, ACT_{—}4) having a gradual effect which depends on a content of the updated listed failure base, the gradual effect aiming to interrupt then start up an execution of tasks APᵢ of the process, according to a startup mode NMDᵢ.

18. A system executing a process comprising a number of tasks APᵢ equal to N, i denoting an index identifying the tasks of the process and being an integer between 1 and N, said system comprising:
at least N computation units UCᵢ each executing the task APᵢ and a failure management device for tasks APᵢ of a process according to claim 16, wherein, when a task AP_{ID} is affected by a current failure, a failure detection time NDAT and a failing task index ID are delivered to the failure management device and in that, when the system detects that a current execution failure affects a task AP_{ID}, it produces a failure detection time NDAT and a failing task index ID addressed to said device.

19. The system according to claim 18, wherein, when a first computation unit UCᵢ of the system transmits a part of the content of the data set Dᵢ of the task APᵢ that it is executing, to a second computation unit UCⱼ of the system, where j is an index different to i, the second unit UCⱼ is capable of ordering a backup of the part of the content of the data set Dᵢ that has been transmitted to it.

20. The system according to claim 18, wherein it comprises means for detecting events external to the system EV, and in that an update of the listed failure base of the task failure management device is triggered by a detection of a system external event EV.

21. The system according to claim 20, wherein the update of the listed failure base comprises a step for initializing the individual counters CPTᵢ for tasks whose indices are stored in a list L₁ which depends on the system external event EV detected by the system.

22. The system according to claim 20, wherein the update of the listed failure base comprises a step for initialization of the startup modes MDDᵢ of a preceding startup for tasks whose indices are stored in a list L₂ which depends on the system external event EV detected by the system.
